(19) United States
(12) Patent Application Publication
(10) Pub. No.: US 2024/0381821 A1
(43) Pub. Date: Nov. 21, 2024

(54) SYSTEM, METHOD AND APPARATUS FOR IMAGER CALIBRATION AND IMAGE COLLECTION WITHIN A FIELD IRRIGATION SYSTEM

(71) Applicant: Valmont Industries, Inc., Omaha, NE (US)

(72) Inventor: Omer Asiskovich, Tel Aviv (IL)

(73) Assignee: Valmont Industries, Inc., Omaha, NE (US)

(21) Appl. No.: 18/657,937

(22) Filed: May 8, 2024

Related U.S. Application Data
(60) Provisional application No. 63/502,963, filed on May 18, 2023.

(51) Int. Cl. A01G 25/16; A01C 23/00; A01G 9/24; A01G 25/02

(52) U.S. Cl. CPC A01G 25/167; A01C 23/007; A01G 9/247; A01G 25/02

(57) ABSTRACT

A system, method and apparatus for imager calibration and image collection within a field irrigation system. According to a first preferred embodiment, the system of the present invention includes imagers, sensors and controllers for calibrating imagers for use within a field irrigation system and for executing an algorithm for analyzing and storing target crop disease image indicators, insect/pest image indicators and crop health/growth image indicators. According to further preferred embodiments, the system of the present invention preferably may analyze these range of factors to determine one or more test chart parameters for use with testing and calibrating one or more imagers.

### RELATED APPLICATIONS

The present application claims priority to U.S. Provisional Application No. 63/502,963 filed May 18, 2023.

### BACKGROUND AND FIELD OF THE PRESENT INVENTION

### Field of the Present Invention

The present invention relates generally to imaging and, more particularly, to a system, method and apparatus for imager calibration and image collection within a field irrigation system.

### Background of the Invention

Modern center pivot and linear irrigation systems generally include interconnected spans (e.g., irrigation spans) supported by one or more tower structures to support the conduits (e.g., water pipe sections). In turn, the conduits are further attached to sprinkler/nozzle systems which spray water (or other applicants) in a desired pattern. In these modern irrigation systems, a significant number of powered elements are used to control various aspects of irrigation. These often include remote and independent power for a variety of sensors, sprayers, drive control systems, motors and transducers.

Most irrigation systems are positioned and designed to traverse fields of crops in accordance with pre-programmed irrigation instructions. In this process, the irrigation systems are equipped to apply water and any range of other applicants according to determined prescriptions. Such prescriptions may be any combination of: pesticides, herbicides, broad spectrum defoliants, fungicides and the like.

Increasingly, data may be compiled by camera/image sensors which are used by growers/operators to monitor field and crop conditions during irrigation operations. However, such imaging devices are often limited in there ability to collect image data due to complex field conditions. Accordingly, image resolution is often poor and data extraction from the images is inaccurate. For example, the positioning of most camera elements on an irrigation system are necessarily static and they depend on the operation of the irrigation system to move the cameras across a given field. This requires such cameras to have the capacity to automatically adjust fields of view to capture images at different ranges and depths. Such adjustments by individual cameras are difficult and cause such cameras to be very expensive and complex. These types of camera technologies are prohibitively expensive and unreliable in the field. Further, these types of cameras are unable to dynamically capture and accurately process images when multiple fields of views are required within closely spaced areas of a given field.

To overcome the limitations of the prior art, a reliable and effective system is needed to allow for the dynamic capture and integration of imaging data from cameras attached to mobile irrigation systems. Further, smart algorithms are needed to enhance the processing of captured image data to allow a grower/operators to identify and react to growing conditions within an irrigated field.

### SUMMARY OF THE DISCLOSURE

To minimize the limitations found in the prior art, and to minimize other limitations that will be apparent upon the reading of the specifications, the present invention provides a system, method and apparatus for imager calibration and image collection within a field irrigation system.

According to a first preferred embodiment, the system of the present invention includes imagers, sensors and controllers for calibrating imagers for use within a field irrigation system and for executing an algorithm for analyzing and storing target crop disease image indicators, insect/pest image indicators and crop health/growth image indicators.

According to further preferred embodiments, the system of the present invention preferably may analyze these range of factors and determine one or more test chart parameters for use with testing and calibrating one or more imagers.

### BRIEF DESCRIPTION OF THE DRAWINGS

FIG. 1 illustrates an exemplary self-propelled irrigation system which may be used with example implementations of the present invention.

FIG. 2A shows an illustration of an exemplary imaging system attached to an irrigation machine in accordance with a first preferred embodiment of the present invention.

FIG. 2B shows an illustration of an exemplary imaging system attached to an irrigation machine in accordance with an alternative preferred embodiment of the present invention.

FIG. 3 is a functional diagram of an exemplary imaging and control system of the present invention.

FIG. 4 is a flow chart illustrating a first set of method steps in accordance with an exemplary embodiment of the present invention.

FIG. 5 is a flow chart illustrating a second set of method steps in accordance with an exemplary embodiment of the present invention.

### DESCRIPTION OF THE PREFERRED EMBODIMENTS

For the purposes of promoting an understanding of the principles of the present invention, reference will now be made to the embodiments illustrated in the drawings and specific language will be used to describe the same. It will nevertheless be understood that no limitation of the scope of the present invention is hereby intended and such alterations and further modifications in the illustrated devices are contemplated as would normally occur to one skilled in the art. The descriptions, embodiments and figures used are not to be taken as limiting the scope of the claims.

Where the specification describes advantages of an embodiment or limitations of other prior art, the applicant does not intend to disclaim or disavow any potential embodiments covered by the appended claims unless the applicant specifically states that it is “hereby disclaiming or disavowing” potential claim scope. Moreover, the terms “embodiments of the invention”, “embodiments” or “invention” do not require that all embodiments of the invention include the discussed feature, advantage or mode of operation, nor that it does not incorporate aspects of the prior art which are sub-optimal or disadvantageous.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Additionally, any examples or illustrations given herein are not to be regarded in any way as restrictions on, limits to, or express definitions of, any term or terms with which they are utilized. Instead, these examples or illustrations are to be regarded as illustrative only.

As used herein, the singular forms “a”, “an” and “the” are intended to include the plural forms as well, unless the context clearly indicates otherwise. Additionally, the word “may” is used in a permissive sense (i.e., meaning “having the potential to’), rather than the mandatory sense (i.e., meaning “must”). Further, it should also be understood that throughout this disclosure, unless logically required to be otherwise, where a process or method is shown or described, the steps of the method may be performed in any order (i.e., repetitively, iteratively, or simultaneously) and selected steps may be omitted. It will be further understood that the terms “comprises,” “comprising,” “includes” and/or “including”, when used herein, specify the presence of stated features, integers, steps, operations, elements, and/or components, but do not preclude the presence or addition of one or more other features, integers, steps, operations, elements, components, and/or groups thereof.

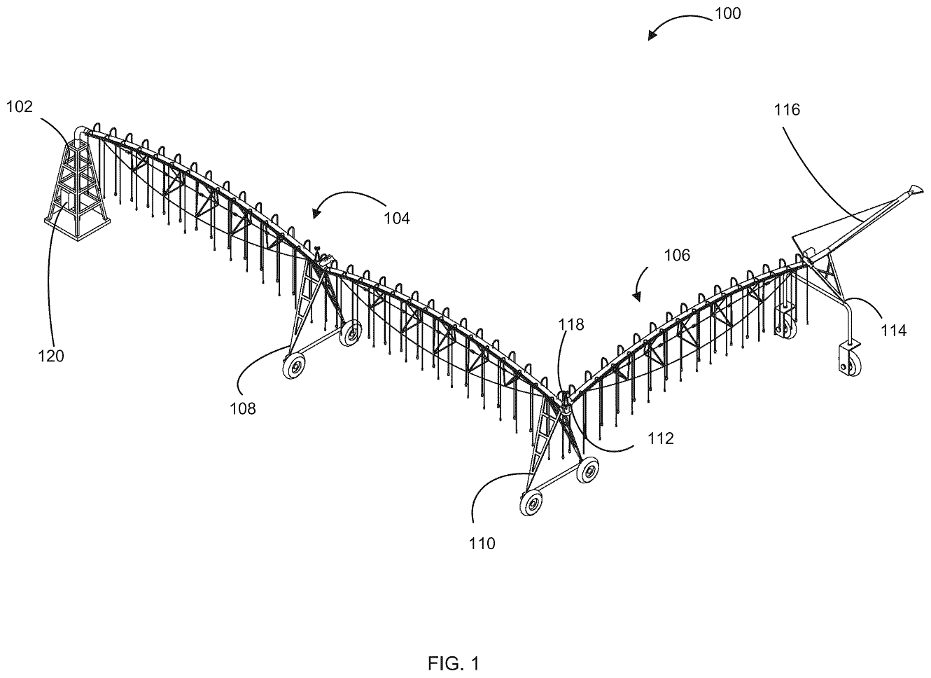

FIG. 1 illustrates an exemplary self-propelled irrigation system 100 which may be used with example implementations of the present invention. As should be understood, the irrigation system 100 disclosed in FIG. 1 is an exemplary irrigation system onto which the features of the present invention may be integrated. Accordingly, FIG. 1 is intended to be illustrative and any of a variety of systems (i.e., fixed systems as well as linear, center pivot and corner systems) may be used with the present invention without limitation.

With reference now to FIG. 1, an exemplary irrigation machine 100 of the present invention preferably may include a center pivot structure 102, a main span 104, and supporting drive towers 108, 110. The exemplary irrigation machine 100 may also include a corner span 106 attached at a connection point 112. The corner span 106 may be supported and moved by a steerable drive unit 114. The corner span 106 may include a boom 116 and an end gun (not shown) and/or other sprayers. Additionally, a position sensor 118 may provide positional and angular orientation data for the system. A central control panel 120 may also be provided and may enclose on-board computer systems for monitoring and controlling the operations of the irrigation machine. The control panel 120 may also be linked to a transceiver for transmitting and receiving data between system elements, device/internet clouds, remote servers and the like.

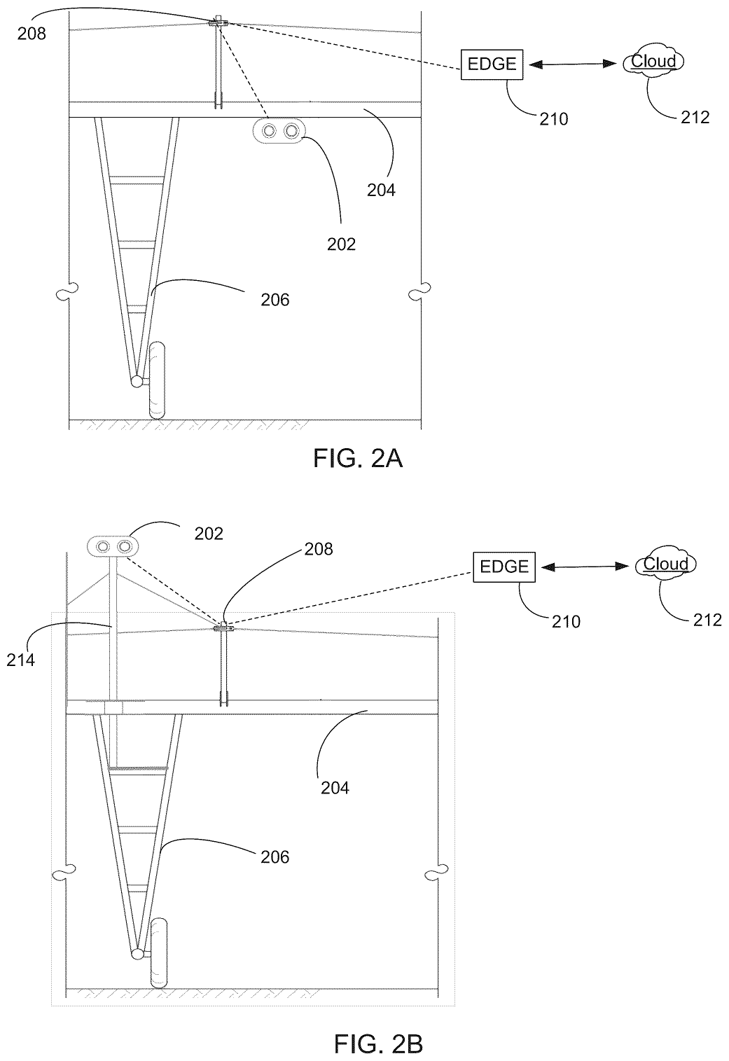

FIG. 2A shows an illustration of an exemplary imaging system attached to an irrigation machine in accordance with a first preferred embodiment of the present invention. As shown, the exemplary irrigation machine includes a span 204 which is supported by one or more drive towers 206. In the example shown, the exemplary imager suite 202 of the present invention may be attached to one or more points on the irrigation machine. For example, the imager suite 202 may be connected along the span 204 as shown. Alternatively, the imager 202 may be attached to the frame of a supporting drive tower 206 or the like as shown in FIG. 2B discussed further below. As shown, the imager suite 202 may be wirelessly linked to wireless elements/routers 208 or other transmitter/reporting devices of any of a variety of protocols (e.g., LoRa, Bluetooth, NFC, Zigbee or the like) which may be attached at various points throughout the irrigation machine to allow data to be collected and/or routed to near, remote or cloud 210 based services for processing and analysis as discussed further below. The imaging system may also include one or more components which are wired or wirelessly linked to local controllers, control panel elements and/or to one or more other reporting or sensor devices. In the examples shown in FIGS. 2A and 2B, the imager suite 202 may preferably transmit data to an edge server 210 (either directly or via a wireless router 208 or the like) which may then store and access data via the Cloud 212 or the like.

According to a further embodiment, the imager suite 202 and/or other imaging controller components may be mechanically isolated from the main span of the irrigation machine.

According to a preferred embodiment, the imager suite 202 (which may include one or more cameras, a controller and transceiver elements as discussed further below) may be located at the center pivot structure (e.g., at or near the central pivot 102 shown in FIG. 1) and may be co-located with or adjacent to central control elements of the irrigation system (e.g., within or adjacent to the central controller unit 120 shown in FIG. 1.) The center pivot structure may preferably be an extended height tripod/monopod as shown in FIG. 1. The imager suite 202 may also be located on an adjacent or attached structure (e.g., an independent pole or platform adjacent or attached to the center pivot structure). Further, the imager suite 202 may be connected to the structure of the irrigation machine at other points including along the irrigation span 204 and/or drive towers 206. FIG. 2B shows an illustration of the exemplary imaging system 202 attached to an irrigation machine in accordance with an alternative preferred embodiment of the present invention. In the example provided in FIG. 2B, the imager suite 202 is mounted on a 2.5 meter pole 214 vertically located on the irrigation machine.

In any configuration and attachment location, the imager suite(s) 202 as discussed herein may preferably be linked and/or interfaced with pivot CPU/controller, other imager suites, and/or to dedicated imager controllers. Such linkage may preferably allow data exchange and coordination between the image suite 202 and the pivot controller. According to further alternative embodiments, multiple imager suites 202 may be provided at different locations on the irrigation machine. Such locations may further include attachment to other field equipment such as harvesters, combines, drones and the like. Further, one or more imager suites 202 may be provided at different surrounding field locations. These additional imager suites 202 may preferably link to and coordinate with each other and/or with the pivot CPU to provide different views in response to changes in irrigation machine characteristics, irrigation prescription status, crop status, image data, and other detected operations and events as discussed further below. The system may further be networked to other equipment (e.g., harvester, drones) independent of any attached imaging suite.

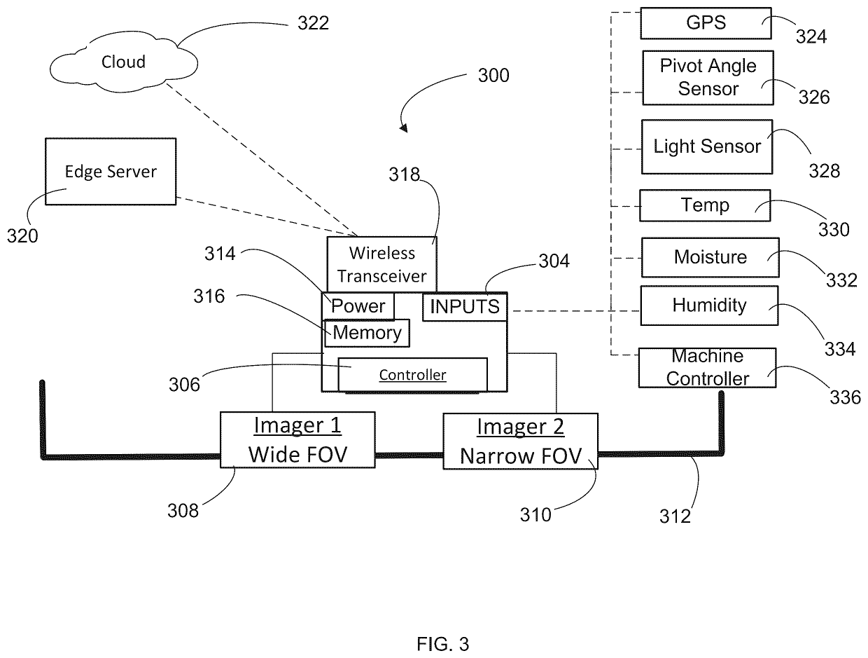

With reference now to FIG. 3, a functional view of an exemplary imaging suite/system 300 in accordance with aspects of the present invention is provided. The imaging suite device 300 may be located within a single sealed housing body or may include multiple imaging elements, chips and circuits which are distributed across several devices and locations. According to a preferred embodiment, the exemplary imaging suite 300 may preferably include two or more imagers/cameras 308, 310 enclosed within a common housing 312. Each imager/camera 308/310 may preferably further include exterior lenses. The imaging suite 300 preferably includes a controller 306 which preferably receives imaging data from the imagers 308, 310 for processing, storage and transmission by the imaging system of the present invention as discussed further below.

Preferably, the controller 306 is programmed to control the functions, operations, and modes of the system of the present invention as discussed further herein. Additionally, the system preferably includes a wireless transceiver 318 for remotely transmitting/receiving data such as digital images to one or more remote edge/processing servers 320 or to a device cloud 322 as discussed further below. The wireless transceiver 318 may preferably use any type of wireless protocol without limitation. These may include Bluetooth, BLE, Wi-Fi, 3-5G, satellite and the like. The wireless transceiver 318 may preferably communicate with and allow remote control and programming of the system 300 via remote server, PDA, smart phone, computer, and the like. Instructions and data may also be received and communicated via one or more wired or wireless data inputs (I/Os) 304. The system of the present invention may preferably include data inputs into the system including data from sensors and systems including for example: GPS/location sensors 324, pivot angle sensors 326, light/heat sensors 328, temperature sensors 330, moisture sensors 332, humidity sensors 334, machine controller/sensor inputs 336 and the like. Each of these sensors may be remotely positioned or integrated within a single housing with the controller 306.

The power system 314 of the present invention may preferably include circuits for receiving power from internal or external batteries, and/or other power sources (i.e., solar, direct wired power etc.) for providing power to the controller 306 and other system elements. The controller 306 may preferably include one or more additional programs/circuits/modules stored in memory 316 for conducting the processes of the imaging system 300 as discussed further below.

### Multi-Lens Imaging Suite.

Referring again to FIG. 3, the imaging suite 300 of the present invention preferably includes two or more imagers/cameras 308, 310 which are each independently capable of collecting image data in the form of light and/or heat detection. In normal use, as discussed above, the imaging suite 300 may be attached to an irrigation tower or span at a height of approximately 4 meters off the ground. Preferably, the separate imagers 308, 310 of the present invention are selected to include at least a first imager 308 having a wide field-of-view (FOV) and a second imager 310 having a narrow field-of-view (FOV).

According to a first preferred embodiment, the imagers 308, 310 of the present invention may each be high-resolution cameras. Examples of such high-resolution cameras may include the e-CAM137A from E-con Systems, the AR1335 from Onsemi or the like. According to a first preferred embodiment, a first imager 308 may be pre-set with a wide FOV to allow the imager 308 to be preferentially tasked with imaging plant characteristics at a Depth of Focus (DOF) of 2.2M-4M from camera. Preferably, the wide FOV imager 308 may allow for a deep DOF such as from the machine ground-base to a height of 2 m or the like.

According to a further preferred embodiment, the second imager 310 may be pre-set with a narrower FOV to allow the imager 310 to be preferentially tasked with imaging plant characteristics at a Depth of Focus (DOF) of 1.5M-4M from camera. Preferably, the narrower FOV imager 310 may allow for a deep DOF to allow the camera to focus from 1M away from the imager 310 to the ground. In this way, the first imager 308 may be preferentially tasked by the system controller 306 to provide images at plant emergence; and the second imager 310 may be preferentially tasked to provide images of smaller objects and crops at increased heights.

According to further preferred embodiments, each imager 308, 310 may include a different lens for each of their preferential tasks. According to a first preferred embodiment, the first imager 308 (wide FOV) may include a lens with the following characteristics: Focal Length: 12.49 mm; F/NO.: 2.4; and H_FOV: 28°. According to a further preferred embodiment, the second imager 310 (narrow FOV) may preferably include a lens with the following characteristics: Focal Length: 16.3 mm; F/NO.: 6.0; and H_FOV: 19°. As discussed further below, the imagers/cameras 308, 310 are preferably connected to the same main board with a proximity that will allow them to capture the same area on the ground or at crop height with a different FOV.

### Imager Control.

Preferably, the controller 306 of the imaging suite 300 of the present invention will receive imaging data and pictures/images from each of the individual imagers/cameras 308, 310. Additionally, the controller may preferably further receive data inputs regarding environmental, crop health and irrigation machine status. With this data, the controller 306 may preferably be programed to manage the functions of the imagers 308, 310 based on one or more of the received data points. According to a preferred embodiment, the controller 306 may preferably receive data regarding the timing/angle of the spin of the pivot/irrigation span and may use this data to control the functions of one or more of the imagers 308, 310. In this way, the operations of the multiple imagers (Wide and Narrow FOV) may preferably be coordinated by the imaging system 300. Accordingly, the controller 306 may control and coordinate the functions/operation of the wide and narrow FOV imagers based on operating conditions and timing/angle of each spin. For example, the controller 306 may coordinate and control the image collection rate and/or autofocus functions of each imager 308, 310 based on the operating conditions and timing/angle of the pivot/irrigation span movement.

Further, the system 300 of the present invention may operate to selectively combine image data and/or collected views from each imager 308, 310 based on system data such as: location, atmospheric conditions, machine data; pivot angle data and the like as discussed herein. Such image processing and control may occur at one or more system elements including at the controller 306, edge server 320, pivot controller, and/or cloud server 322. According to a further preferred embodiment, the controller 306 may initiate time lapsed image collection which may be triggered by mechanical events, field conditions and/or crop conditions. Further, the controller 306 may trigger selected views, zoom settings and/or image collection rates (including time lapsed images) which the controller 306 may time sync with mechanical events and/or detected mechanical, environmental or crop conditions.

### Image Processing.

According to further preferred embodiments, the system of the present invention may preferably process collected images (including time lapsed images and video) to select and present collections of images based on pre-selected image report parameters. For example, an operator may select and/or define image reports which provide curated images with data for relevant conditions based on mechanical events, spin angles, environmental conditions and other system data discussed herein. In this process, the system may preferably select images from Wide and Narrow FOV imagers etc. and may allow the operator to toggled between images based on data indicating pre-defined events and conditions. Such selective processing and image selection may be performed on the image controller 306, edge server 320 and/or at a remote server/Cloud 322 based on Wi-Fi strength, power, battery levels and/or other system parameters.

Further, the present invention may process images to analyze fine image details. Exemplary characteristics which may be analyzed may include:
Water beading metrics. Analysis of characteristics of water beading (i.e., bead size, bead number) to determine/measure health of foliage. Water beading characteristics may be linked to crop health which may be indicated by the permeability/waxiness of foliage.
Foliage discoloration, shading or staining. Analyzing shades of foliage color and staining may be performed to determine quality of water or applicant (i.e., hard water, mineral levels) and/or foliage health.
Insect Analysis. Analyzing images to detect insect data such as sex, age, size, health, growth stage, and activity rates of pests/insects. These detected metrics may be correlated to crop health and may further be used to target and time treatments.
Cooling rate metrics. Analyzing of crop/foliage/canopy cooling rates to determine crop growth rate/health. Crop cooling rates may be correlated to healthy, well-watered foliage versus foliage in other conditions.

### Testing Chart Selection and Calibration.

To calibrate the imagers 308, 310 to detect fine details in a variety of settings, the present invention preferably further includes methods for selecting test charts and calibrating the lenses of the present invention. Usually, resolution and object detection are tested using charts with closely spaced black and white lines. These charts test the ability of a lens configuration to measure separation, resolution, modulation transfer function (MTF), and other characteristics. In accordance with methods of the present invention, the systems of the present invention preferably select, create and incorporate testing charts in a variety of shades and colors which correspond to determined crop targets and environmental conditions. According to preferred embodiments, the systems of the present invention may preferably include the selection and use of testing charts which are produced in environmentally targeted colors and shades such as green and brown color palettes. Preferably, charts of the present invention may include 0.5 mm and 1 mm green lines with precisely selected RGB values (e.g., RGB: 70, 148, 73).

Preferably, the systems and methods of the present invention may define and select a background color/shade for each test chart for a variety of different purposes and backgrounds. For example, a green/white chart (i.e., background gradient changing from the defined green to an absolute printable white) may be selected for specific crops and/or foliage at specific growth periods. In another example, a green/brown chart (i.e., background gradient color changing within color ranges for green and/or brown colors (e.g., Dark: 100,75,29-Bright: 200,147,44)) may be defined and used for image collection in different soil types and can mimic crop emergence on different soils.

In creating, defining and selecting testing charts, the systems of the present invention may preferably select color palettes and shades based on images of defined crop conditions monitored by the imaging system of the present invention. For example, the systems of the present invention may analyze different anomalies in plants which occur at specific seasons and growth stages of a selected crop. Based on color analysis of defined crop and environmental data related to the targeted crop condition, the systems of the present invention preferably may create a testing chart in a specific gradient color for a specific crop, anomaly, condition and/or disease. For example, the system/method of the present invention may analyze images of blight (e.g., including blight at various stages such as early blight on corn plants and late blight on potatoes) to produce a color chart having a specific gradient color to test imagers for the detection of this disease.

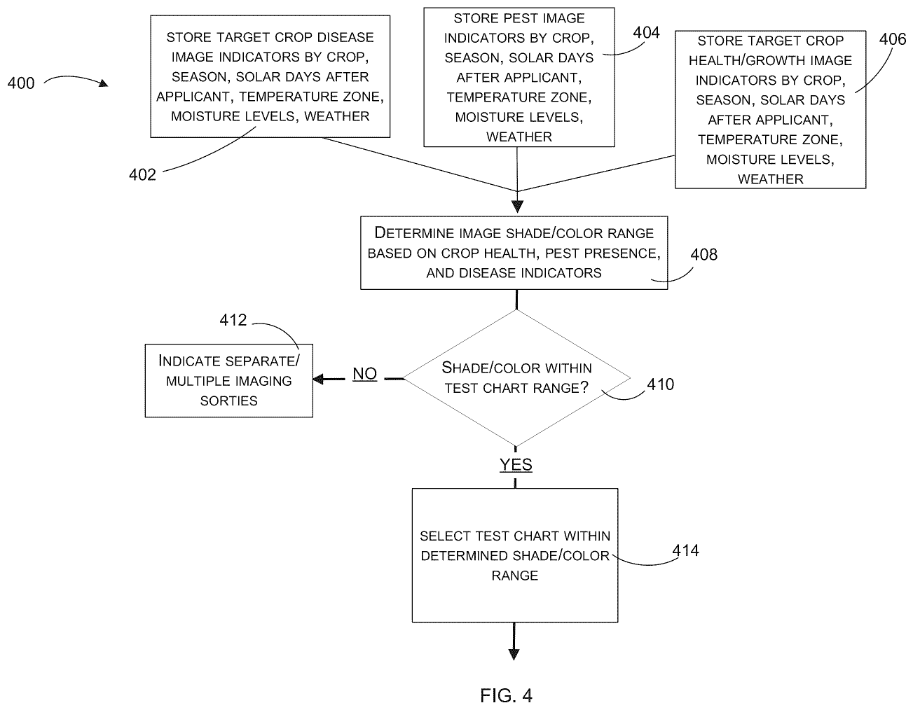

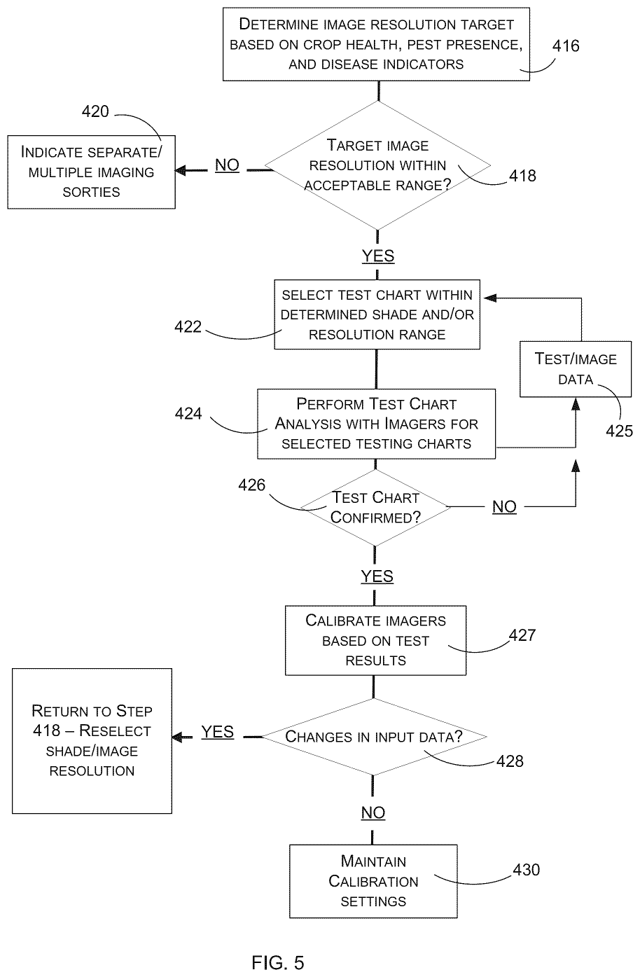

With reference now to FIGS. 4-5, exemplary steps of a first preferred method 400 implementing aspects of the present invention will now be discussed. Referring now to FIG. 4, at a first step 402, the system may preferably store target crop disease image indicators by factors such as region, crop, season, solar days after applicant, temperature zone, moisture levels, and historic/current weather conditions. At a next step 404, the system of the present invention may further store insect/pest image indicators by factors such as region, crop, season, solar days after applicant, temperature zone, moisture levels, and historic/current weather conditions. At a next step 406, the system may preferably further store target crop health/growth image indicators by factors such as region, crop, season, solar days after applicant, temperature zone, moisture levels, and historic/current weather conditions. According to preferred embodiments, for each of steps 402, 404 and 406, the stored data of the present invention may preferably be stored/uploaded from a first set of storage/acquiring devices to an edge server and then uploaded to the cloud for continual access by the systems of the present invention.

At a next step 408, the system may determine image shade/color gradients/ranges based on crop disease, insect/pest and health/growth image indicators and factors. At a next step 410, the system may determine whether the determined shade/color is within a given test chart range. At a next step 412, if the range of shade/color is outside of given threshold, the system may indicate that multiple test charts and potentially additional imagers and/or imaging sorties may be required to scan for the potential anomalies. At a next step 414, the system may then select, configure and/or produce the selected test chart within the determined shade/color ranges.

Referring now to FIG. 5, at a next step 416, the system may next determine image resolution targets based on crop disease, insect/pest and health/growth image indicators and factors. At a next step 418, the system may determine whether the determined target image resolution is within an acceptable test chart range. At a next step 420, if the range of the image resolution is outside of given threshold, the system may indicate that multiple test charts and potentially additional imagers and/or imaging sorties may be required to scan for the potential anomalies. At a next step 422, the system may then select, configure and/or produce the selected test chart(s) within the determined shade and/or image resolution range. At a next step 424, the system may then initiate and perform imaging tests for each imager using the selected testing charts. According to a preferred embodiment, the image tests preferably produce image/calibration data for each imager. At step 425, the image/calibration data from the selected test charts may be further analyzed to confirm the test chart selection and/or to reselect another test chart when specific image/calibration data fall outside pre-set thresholds. When threshold values are met, the test chart selection may be confirmed at a next step 426.

At a next step 427, the system may calibrate each imager based on the test results. At a next step 428, the system preferably monitors for changes in any input data. If input data has changed, the system preferably may return to step 418 and reselect an imaging chart based on both newly calculated shade and image resolution targets. If the input data has stayed the same (or within preset thresholds), at a next step 430, the system may preferably maintain the calibration settings for the imager(s) and may continue to monitor the input data.

While the above descriptions regarding the present invention contain much specificity, these should not be construed as limitations on the scope, but rather as examples. Many other variations are possible. For example, the communications provided with the present invention may be designed to be duplex or simplex in nature. Further, the systems of the present invention may be used with any arrangement of drive towers including both linear and center pivot systems. Further, as needs require, the processes for transmitting data to and from the present invention may be designed to be push or pull in nature. Still, further, each feature of the present invention may be made to be remotely activated and accessed from distant monitoring stations. Accordingly, data may preferably be uploaded to and downloaded from the present invention as needed.

Accordingly, the scope of the present invention should be determined not by the embodiments illustrated, but by the appended claims and their legal equivalents.

What is claimed is:

1. A system for calibrating imagers within a field irrigation system, the system comprising:
a location sensor;
a plurality of environmental sensors; wherein the environmental sensors comprise one or more sensors selected from the group of sensors comprising: a temperature sensor; a light sensor; a moisture sensor; and a humidity sensor;
a plurality of machine sensors; wherein the machine sensors comprise one or more sensors selected from the group of sensors comprising: a pivot angle sensor;
a first imager; wherein the first imager has a first field of view (FOV);
a second imager; wherein the second imager has a second field of view (FOV);
wherein the first FOV is wider than the second FOV;
an imager controller; wherein the imager controller is configured to receive and process data from at least the first imager and the second imager;
wherein the imager controller is configured to analyze imager data for the presence of target crop disease image indicators; wherein the target crop disease image indicators are selected and stored by the system and linked to a first set of corresponding data; wherein the first set of corresponding data comprises two or more points of data selected from the group of corresponding data comprising: crop data, location data; environmental data; pest data, solar days after applicant, temperature zone, and moisture level data;
wherein the image controller is configured to analyze imager data for the presence of pest image indicators; wherein the pest image indicators are selected and stored by the system and linked to a second set of corresponding data; wherein the second set of corresponding data comprises two or more points of data selected from the group of corresponding data comprising: crop data, location data; environmental data; pest data, solar days after applicant, temperature zone, and moisture level data;
wherein the image controller is configured to analyze imager data for the presence of crop growth image indicators; wherein the crop growth image indicators are selected and stored by the system and linked to a third set of corresponding data; wherein the third set of corresponding data comprises two or more points of data selected from the group of corresponding data comprising: crop data, location data; environmental data; pest data, solar days after applicant, temperature zone, and moisture level data.;

2. The system of claim 1, wherein the imager controller is configured to select an image chart for calibration of at least one of the first imager and the second imager based on the crop disease image indicators, pest image indicators and crop growth image indicators linked to detected corresponding data.

3. The system of claim 2, wherein the imager controller is configured to select an image chart for calibration of at least one of the first imager and the second imager based on a determined image shade range.

4. The system of claim 3, wherein the imager controller is configured to determine whether the first determined image shade range is within a first test chart range.

5. The system of claim 4, wherein the imager controller is configured to create an alert when the first determined image range is outside of the first test chart range.

6. The system of claim 5, wherein the imager controller is configured to select a first image chart for calibration; wherein the first image chart is selected based on a first image chart parameter; wherein the first image chart parameter is selected from the group of image chart parameters comprising: image resolution, gradient, shade and color range.

7. The system of claim 2, wherein the imager controller is configured to select an image chart for calibration of at least one of the first imager and the second imager based on determining an image resolution target.

8. The system of claim 7, wherein the imager controller is configured to output a first set of test chart parameters for the production of a first produced test chart.

9. The system of claim 8, wherein the first set of test chart parameters comprise one or more image chart parameters selected from the group of parameters comprising: image resolution, gradient, shade and color range.

10. The system of claim 9, wherein the imager controller is configured to initiate imaging tests for at least one of the first imager and the second imager using the first output test chart.

11. The system of claim 10, wherein the imager controller is configured to calibrate at least one of the first imager and the second imager based on a first imaging test result.

12. The system of claim 6, wherein the imager controller is configured to select an image chart for calibration of at least one of the first imager and the second imager based on determining an image resolution target.

13. The system of claim 12, wherein the imager controller is configured to create a first set of test chart parameters for the production of a first produced test chart.

14. The system of claim 13, wherein the first set of test chart parameters comprise one or more image chart parameters selected from the group of parameters comprising: image resolution, gradient, shade and color range.

15. The system of claim 14, wherein the imager controller is configured to initiate imaging tests for at least one of the first imager and the second imager using the first output test chart.

16. The system of claim 15, wherein the imager controller is configured to calibrate at least one of the first imager and the second imager based on a first imaging test result.

17. The system of claim 16, wherein the imager controller is configured to analyze the size of water beads on a first target plant foliage.

18. The system of claim 17, wherein the imager controller is configured to analyze the size of water beads on the first target plant foliage to determine whether the waxiness of a first target plant foliage falls within a first threshold range.

19. The system of claim 18, wherein the imager controller is configured to analyze the shades of foliage color on a second target plant foliage.

20. The system of claim 19, wherein the imager controller is configured to analyze the shades of foliage color on the second target plant foliage to determine the foliage health.

21. The system of claim 20, wherein the imager controller is configured to analyze insect image data; wherein the insect image data comprises data selected from the group of insect data comprising: sex, age, size, health, growth stage, and activity rates.

22. The system of claim 21, wherein the imager controller is configured to detect and analyze a set of cooling rate data for a third target foliage.

23. The system of claim 22, wherein the cooling rate data comprises the rate of temperature change for the third target plant foliage within a first time period.
